(19) United States
(12) Patent Application Publication
(10) Pub. No.: US 2008/0034328 A1
(43) Pub. Date: Feb. 7, 2008

(54) Navigation Method

(75) Inventors: Paul Bruce Cahill, Como (AU); Michael Roy Liu, Como (AU)

Correspondence Address: EDELL, SHAPIRO & FINNAN, LLC, 1901 RESEARCH BOULEVARD, SUITE 400, ROCKVILLE, MD, 20850, US

(73) Assignee: WORLDWATCH PTY LTD, Como (AU)

(21) Appl. No.: 11/757,682

(22) Filed: Jun. 4, 2007

Related U.S. Application Data
(63) Continuation of application No. PCT/AU05/01804, filed on Dec. 1, 2005.

(30) Foreign Application Priority Data
Dec. 2, 2004 (AU) 2004906969

(51) Int. Cl. G06F 3/048; G06F 17/30; G06Q 30/00

(52) U.S. Cl. 715/855; 705/26

(57) ABSTRACT

A method for navigating to information includes: displaying a first geographic image; receiving input from an input device that selects a location on the first geographic image; and retrieving an information segment related to the selected location.

### CROSS REFERENCE TO RELATED APPLICATIONS

This application is a continuation of International Application No. PCT/AU2005/01804, filed on Dec. 1, 2005, entitled “Navigation Method,” which claims priority under 35 U.S.C. §119 to Application No. AU2004906969 filed on Dec. 2, 2004, entitled “Navigation Method,” the entire contents of which are hereby incorporated by reference.

### FIELD OF THE INVENTION

The present invention relates to a method of navigating to information and also relates to the provision of services relating to the information found using the navigation method.

### BACKGROUND

Free-to-air and pay television provide a simple method of navigating to find information in the form of a video and audio presentation. The navigation method is simply the choice of a channel. In this method all the information available is transmitted to the receiver and only the information selected via the chosen channel is provided to the viewer. Furthermore the information provided is at the discretion of the channel, that it is determines what is on the channel at what time.

Providing movies through global communication networks, such as the Internet usually occurs in one of two ways: firstly, by selecting a channel in a similar manner to selecting a channel on a television; secondly, by navigating through to the desired information by selecting links. The links form part of static or dynamically generated web pages. Dynamically generated world wide web pages are often created by search engines as a result of entering search criteria in the form of keywords. In the case of information provided by a channel, information from non-selected channels is not provided to the receiving device.

The present invention provides an alternative approach to navigating to find information.

### SUMMARY

According to a first aspect of the present invention there is provided a method of navigating to information comprising:

displaying a first geographic image;

receiving input from an input device that selects a location on the first geographic image;

retrieving an information segment related to the selected location.

Preferably the method further comprises providing a library comprising a plurality of information segments, where each information segment is related in some way to a geographic location and at least some of the information segments are related to different geographic locations so that the information segment(s) related to the selected geographic location can be retrieved from the library.

In a preferred embodiment the information includes a video sequence. Usually the information further includes an audio track.

In one embodiment information segments have a respective icon associated wherewith, wherein each icon is displayed over the relevant location on the geographic image. In this embodiment the location on the geographic image is selected by selecting the icon associated with that location.

In an embodiment the information segments have searchable information associated therewith. The searchable information is searched to identify information segments and thus their associated geographic locations at which the searched information is relevant. The locations which meet nominated search criteria indicate that they meet the search criteria by display of an alternate icon. The preferred form of the alternate icon is a relative enlargement of the icon.

Often a plurality of information segments will be available that relate to the selected geographic location. One or more of these information segments may be selected for display. In one embodiment the selection is made by displaying a magnified geographic image, wherein the information segments become geographically spaced apart so that they can be differentiated and selected by selecting a further location on the magnified geographic image.

A high level geographic image may be displayed which has a plurality of lower level geographic images associated with relevant portions of the high level geographic image. In the event that a lower level geographic image has one or more icons associated therewith for selection then the higher level geographic image has an icon displayed over the relevant portion of the high level geographic image.

In another embodiment each geographic image is dynamically generated. In this embodiment the icons are dynamically positioned on the geographic image.

In the event of an icon displayed on the high level map being selected then the image zooms in on the corresponding low level image and respective icons. Preferably the zooming is displayed as a journey. Usually the first geographic image is one of many low level images associated with a higher level geographic image. Often the higher level geographic image is one of many higher level geographic images associated with a further higher level geographic image. Preferably the highest geographic image is a map of the world.

According to a second aspect of the present invention there is provided a method of displaying information comprising:

navigating to the information according to the above navigation method; and displaying the information selected by the navigation method.

According to a third aspect of the present invention, there is provided a method of creating an active link to media content for use with a browser, the method comprising:

associating the link with a geographic location;

overlaying an icon on the location on a geographic image; and,

waiting for selection on the icon;

upon section of the icon the link is activated to cause the browser to access the media content;

whereby activation of the link initiates transfer of the media content to the browser.

The method may further include the step of associating searchable information related to the location and/or the media content with the link so that the searchable information can be searched to determine whether a user activates the link.

Preferably, a plurality of icons are displayed on the geographic image, the icons displayed are selected from a library of links with corresponding icons having an associated geographic location corresponding thereto, the icons displayed are selected according to those links that have an associated geographic location on the area of the geographic image displayed.

According to a fourth aspect of the present invention, there is provided a method of selecting media content linked to an icon for display on a browser, the method comprising:

providing an icon for accessing a link by selection of the icon, the icon being displayed over a geographic image;

providing a plurality of media content related to the geographic location;

associating searchable information related to each item of media content with the respective item of media content;

receiving a selection of the searchable information; and,

linking selection of the icon to the respective media content according to the selected searchable information.

Preferably, the searchable information is related to one or more of the following: a direction of view at the geographic location;

a subject covered by the media content and,

a time of day, month and/or year the information was obtained from the geographic location.

Preferably, the searchable information is displayed for selection.

According to a fifth aspect of the present invention there is provided a method of service provision comprising:

providing information by selecting a geographic location on a map;

providing a link to a service related to the information or the geographic information from the selected information or displayed at the same time as the geographically selected information; and

in the event that the link is activated then providing the service.

The service may be a retail service, a charity collection service, an organization membership service or some other service.

According to a sixth aspect of the present invention there is provided a business method comprising:

providing a service of navigating to information as described above; and

charging by any one or more of the following methods:

charging for access to the service;

charging for each information segment provided; and

charging for transactions.

According to a seventh aspect of the present invention there is provided a computer program for controlling an information processing device (such as a computer) to operate according to one or more of the above described methods.

According to an eighth aspect of the present invention there is provided a computer readable storage medium for storing a computer program as defined above.

According to a ninth aspect of the present invention there is provided an apparatus for performing any of the above methods comprising means for conducting each of the steps of the methods described above.

### BRIEF DESCRIPTION OF THE DRAWINGS

In order to provide a better understanding of the present invention preferred embodiments will now be described, by way of example only, with reference to the accompanying drawings in which:

FIG. 1 is a schematic representation of a geographic image displayed according to an embodiment of the present invention;

FIG. 2A is one frame from animated zooming journey from the high level geographic image of FIG. 1 to a low level geographic image;

FIG. 2B is another frame from animated zooming journey from the high level geographic image to the low level geographic image;

FIG. 2C is another frame from animated zooming journey from the high level geographic image to the low level geographic image;

FIG. 3 is the low level geographic image displayed according to the same embodiment of the present invention;

FIG. 4 is the low level geographic image of FIG. 3 showing an enlarged eye icon and annotation balloon when a cursor is placed over the icon;

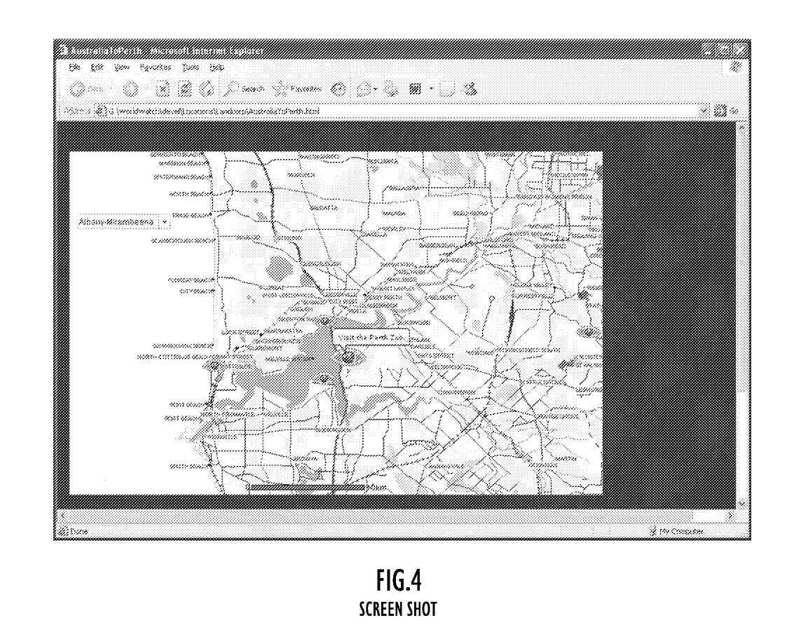

FIG. 5 is a schematic view of a place (a zoo) in a window overlaying the low level geographic image of FIGS. 3 and 4;

FIG. 6 is the view of the zoo of FIG. 5 showing an enlarged eye icon and annotation balloon when a cursor is placed over the icon;

FIG. 7A shows another window overlaying the window in FIGS. 5 and 6 in which a video sequence plays, one frame of which is shown;

FIG. 7B shows another frame of the video sequence played in the second overlayed window;

FIG. 8 is a sequence diagram showing the sequence of activities conducted in the present invention;

FIG. 9 is a use case diagram showing the cases of a user using an embodiment of the present invention;

FIG. 10 is an activity diagram showing steps involved in the operation of an embodiment of the present invention;

FIG. 11 is a use case diagram showing the interrelation of processes created by a media author actor and media editor actor;

FIG. 12 is a use case diagram of use cases from the main actor “World Eye Editor” according to an embodiment of the present invention;

FIG. 13 is a class diagram outlining important classes of objects and the attributes, behaviors and relationships with other classes, focusing on an object class named WorldWatchEye, according to an embodiment of the present invention; and,

FIG. 14 is another class diagram outlining important classes of objects and the attributes, behaviors and relationships with other classes, focusing on an object class named ObjectInSpace, according to an embodiment of the present invention.

### DETAILED DESCRIPTION

The present invention provides an interactive method of navigating to find information. Often the user performing the navigation will start from one or more portals at publicly accessible world wide web sites. The user will access the web site through a browser software application loaded on an Internet connected computer. The browser will have appropriate audio visual plug-ins installed. The portal is provided to users of the Internet from one or more server computers connected to the Internet.

The present invention includes a billing model to charge for access to the information found using the present invention. Accordingly it is desirable for the user to be known to the server by a login method, usually by logging into the portal.

The user, once logged in, can explore locations around the world by use of the present invention. The user can navigate by a combination of entering key words to obtain search criteria in the usual manner, selecting icons/text link in the usual manner and selecting geographic locations from a map to trigger the presentation of information. Information can be presented in text form, in still images, but most preferably in a video format with moving pictures and an audio soundtrack. The entry of keywords can occur at a number of different stages during the process as will be described below, but in the present invention the user is at some stage presented with a geographic image, typically in the form of a map, for selection of a location on the map.

At a general level the present invention provides a journey around the world (or a part thereof) to view a video presentation of things of interest related to the location traveled to. It is noted that a video may be a still image, a moving image, and either may be overlayed with selectable icon for further travel.

Not every position on a map will have a video associated with it, so identifying which positions have videos is made easier by indicating them with an icon. The icon functions as a link to the video. In the preferred embodiment the icon has searchable information associated with it so that if more than one video is available, the video may be selected by selection of the searchable information related to the video desired to be seen.

When an icon is selected, the focus of the window will shift from the current scene to a new scene. The transition represents a journey that must occur before the picture at the new scene is presented. The journey from one location to another or zooming into a location is also part of the experience. At the selected location one or more videos can be viewed.

A high level map may include icons of features of a lower level map depending on their position in the space in which the user is currently viewing (usually through a window of the browser or plug-in), as well as other constraints. If the size of the map covers locations with associated icons, those icons that are within the coordinates of the map will be displayed and those that are not will not be shown on the map, and therefore will not be available for section on the current map. If the scale of the map is large enough, features may be grouped so that only one is shown, but as the user drills down, the icon will separate into the features that were grouped together. It is noted that a map may be panned so as to bring other portions of a landscape (and thus icons) into view.

It is noted that the location and area (place) that the user is taken to is usually predefined. That is the destination is usually the result of the filming, photograph or whatever of the destination. The area of view of the destination need not be defined as it may be related by subject only.

Each icon may include a synopsis movie scene that is presented to the user to give an overview of what may be viewed if the user selects a particular icon. The synopsis may be text or it may be a movie having audio and visual content.

A feature of a location may be indirectly selected from any other icon space (another map) and therefore the user is taken on a journey to arrive at the new icon's location. There may be an infinite number of locations from which the journey commences, therefore the journey must be specifically made for that instance. After taking the journey from the old location to the new location, the destination movie scene is presented. The movie forms the main attraction of the experience provided by the present invention and is presented before the scene features. Destinations may have a destination loop that is presented with the destination features. This may be a repeating video sequence or a simple static audio/visual presentation.

An amplifier facility may be provided that allows the user to enter information about subject matter they may be interested in. Each icon may have an association with many keywords that describe the subject being presented. Where there is a match between the keyword and the subject matter sought, the icons can be annotated to indicate their importance to the topic sought. In some circumstances it may be necessary to present icons as features of one or more other icons. This allows a media editor to arbitrarily group one or more icons as features within the movie scene of one or more other destinations. This allows related subject matter to be linked even though they may or may not be related to the same geographic location.

The appearance of each icon may vary depending on the category feature it represents, the amplification factor of the feature and the direction and field of view from the destination. The appearance of the icons may also vary depending on the client whose information is being presented. For example a zoo may have a logo that can be used instead of the eye example used in this description. Furthermore other features may determine the icon used, such as for example a directional icon which indicates the direction of view of the scene displayed if the icon is selected. This feature may be extended to allow the user to select a view direction (if indicated by the icon) by for example rotating a mouse around the icon holding down the mouse button. Another example is to use a cluster icon to indicate that other icons are selectable underneath.

Each destination-may-be-associated with a number of actions that may be triggered by the user. Some of these actions will be standard actions that provide the user with some associated activities such as shopping for related products, joining interest groups, making donations, joining relevant organizations and various other specialized activities that will be related to the subject matter of the destination.

The present invention may be more readily understood in light of the following example.

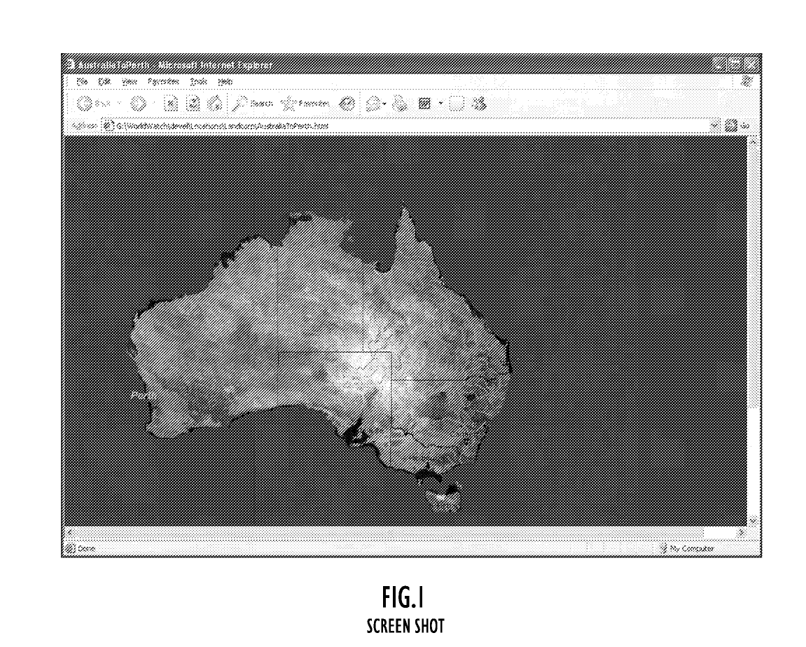

FIG. 1. shows an example of a map of Australia with the word ‘Perth’ forming an icon above the location of the city of Perth on the Australian map.

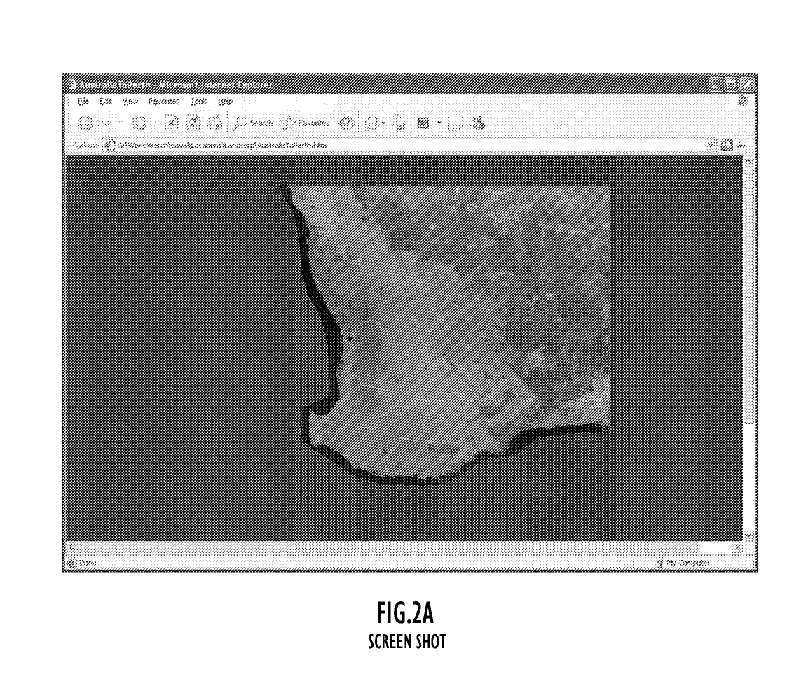

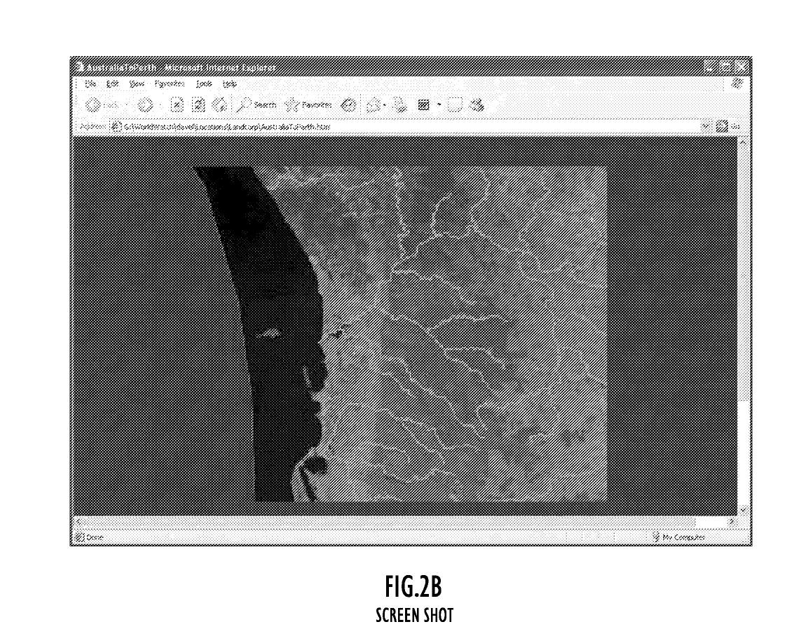

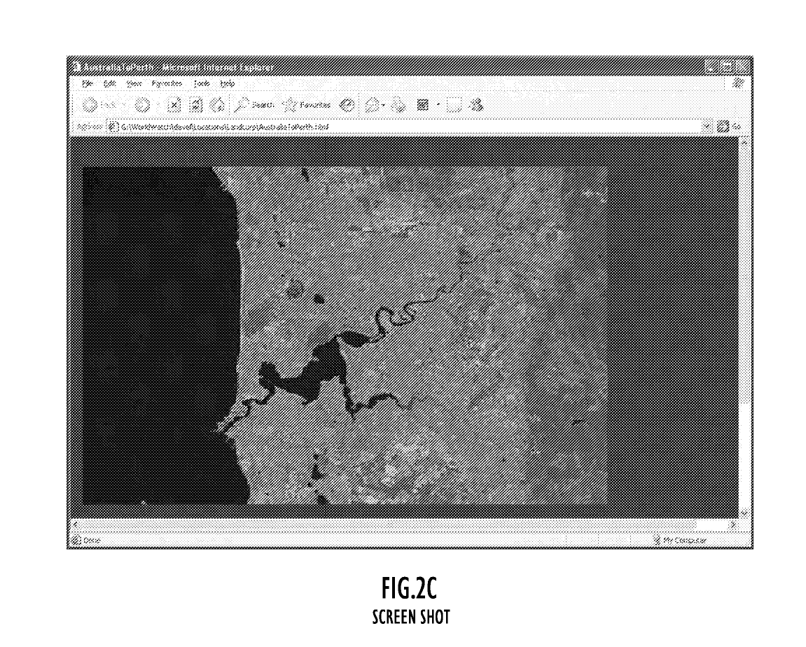

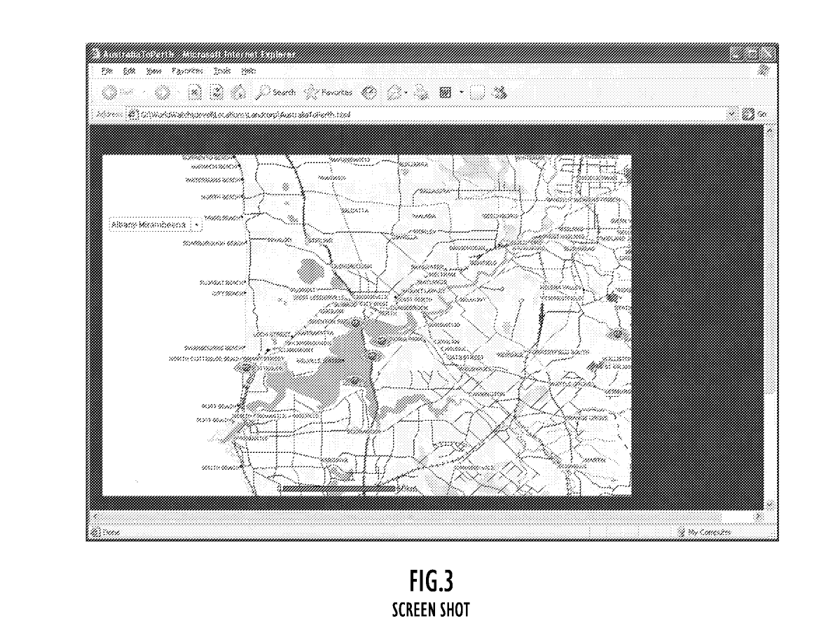

The Perth icon may be selected in the usual manner, that is, by moving a cursor over the icon and clicking a mouse button or by the use of some other input device. This will activate a journey presentation where the image zooms in, as illustrated by FIGS. 2A, 2B, 2C and 3 which are a sequence of frames of the zoom in.

FIG. 2A is an enlarged view of the south west of Western Australia. At the center of the map is Perth. FIG. 2B shows a further zoomed in view, substantially of the larger metropolitan area of Perth with the city of Perth at the center of the map. FIG. 2C shows the central metropolitan area showing the Swan River, with the city of Perth located on the northern bank.

FIG. 3 shows a map of the central metropolitan area of Perth overlaid with major roads and rail lines. Seven eye shaped icons are shown overlaying the map. The icon is described as being an eye; however, this may not be the case. The icons are located at significant tourist destinations of Perth. For example the western most eye icon is situated over Cottesloe Beach, the northern most of the central group of eyes is located over Kings Park, the next eye down is located over the South Perth foreshore which looks across the Swan River to the city of Perth skyline. The next eye is located over the Perth zoo and the next eye down is located on the southern bank of the Swan River looking towards Kings Park. The eastern most eye is located over a location in the suburb of Kalamunda.

The user can select one of the icons located over a geographic location on the map. The user's cursor hovers above the icon over the Perth zoo. The eye icon is enlarged and has a comment balloon with the words “Visit the Perth Zoo”. In this example it is assumed that the user selects the icon over the Perth zoo. Optionally another animation is then played to the user following the selection of an eye icon. The animation is of the zoom in from over Perth to see a plan view of the site of the Perth zoo.

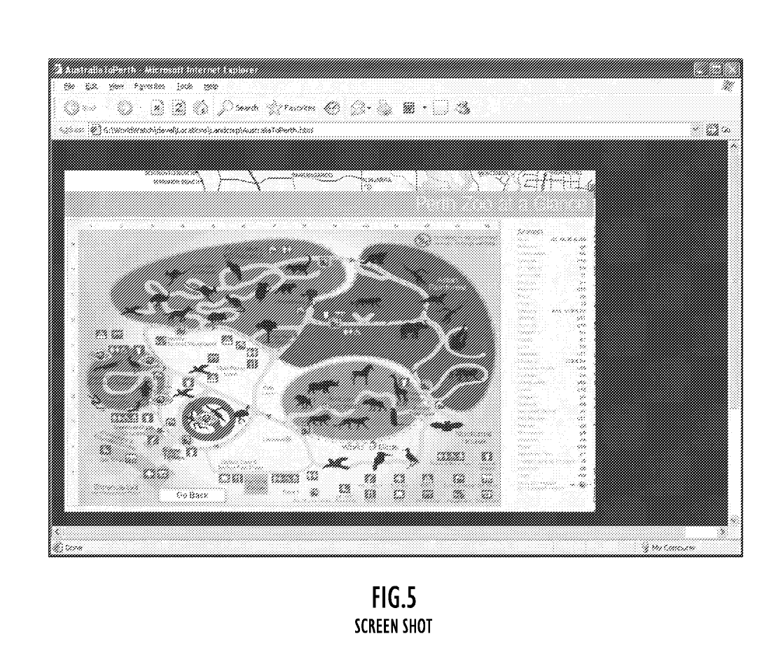

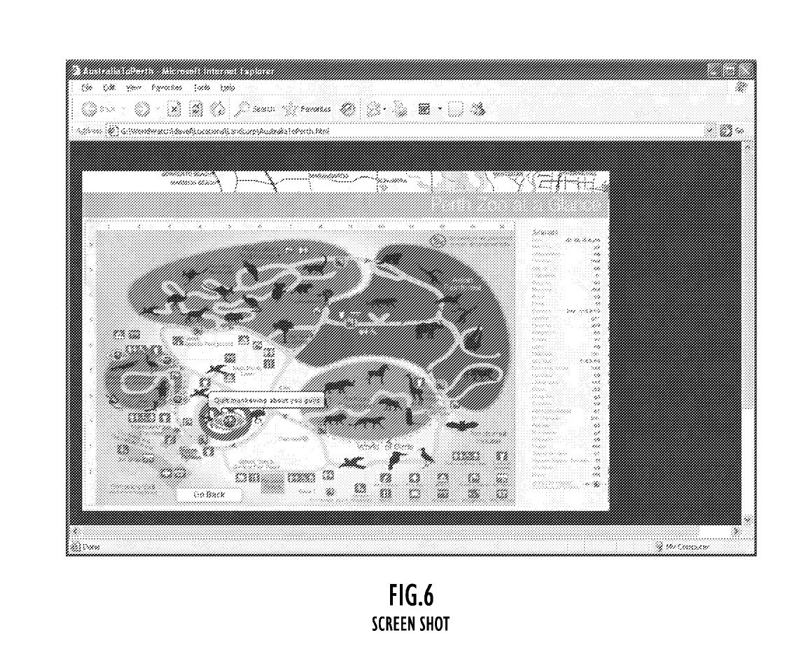

In one version, a video related to the Perth zoo then begins. However, in this example a map of the Perth zoo, such as in FIG. 5, is presented. The user is shown and may select one of the various exhibits. The types of exhibits currently available at the Perth zoo are an African zone showing African savannah animals, an Asian rainforest zone including an orangutan exhibit, an Australian bushwalk showing various Australian fauna as well as some other exhibits including a nocturnal house and bird exhibit. In FIG. 6, the user hovers their cursor over an exhibit. The eye icon is shown enlarged and the comment balloon reads “Quit monkeying about you guys”.

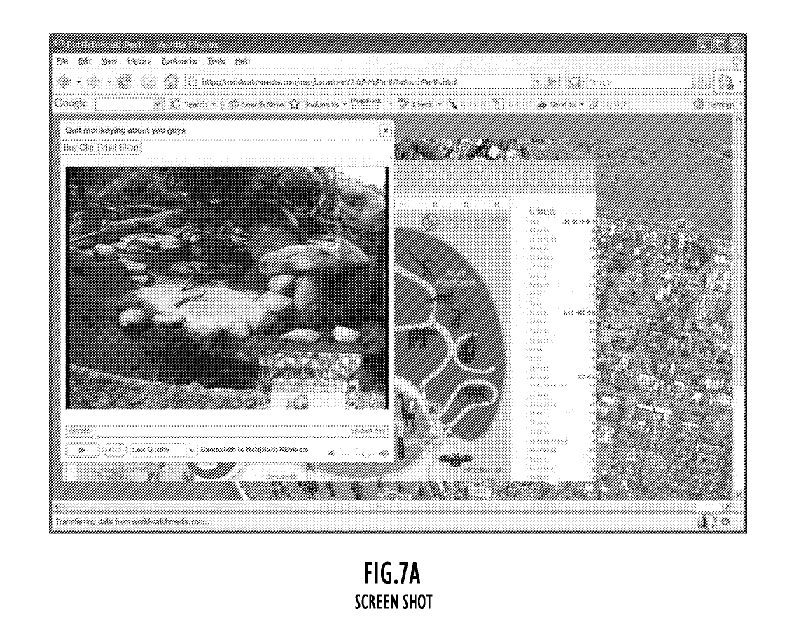

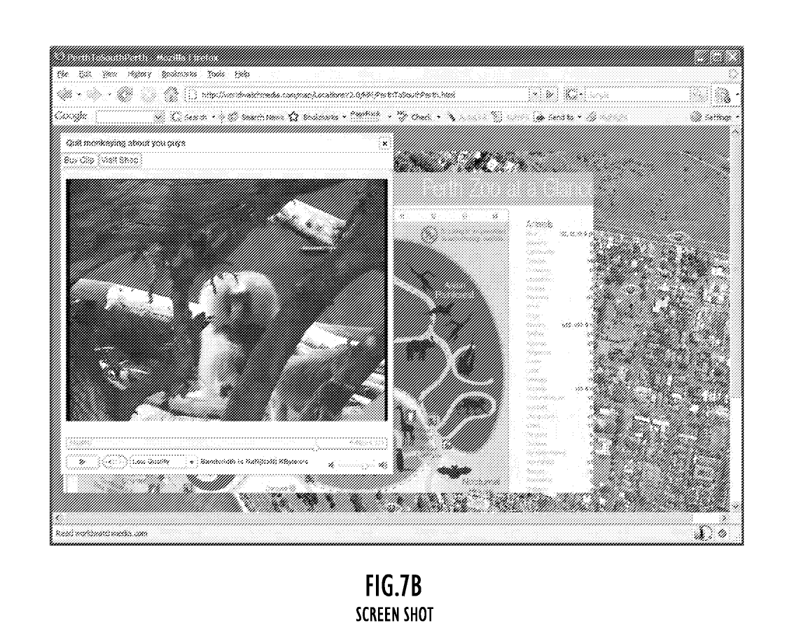

If the user clicks on this icon, a film begins in a pop-up window complete with a soundtrack including background sound and/or recording of sound from the location along with commentary. FIGS. 7A and 7B show frames from the video.

If the user is particularly interested in orangutans they may enter the keyword “orangutan” in a search facility. The user will then be taken to a short film describing the orangutan and showing the orangutans. A more elaborate version may show a number of films, such as for example a film of the zoo keeper, a description of orangutans, a film related to the orangutan's natural habitat, a description of the orangutans diet, conservation information regarding the orangutans endangered species status. These short films may be viewed in sequence or may be selected randomly by the user from an image map containing the other subject icons.

Numerous other features can be provided through this portal website as will be described further below. Other examples of use of the portal website will also be described further below.

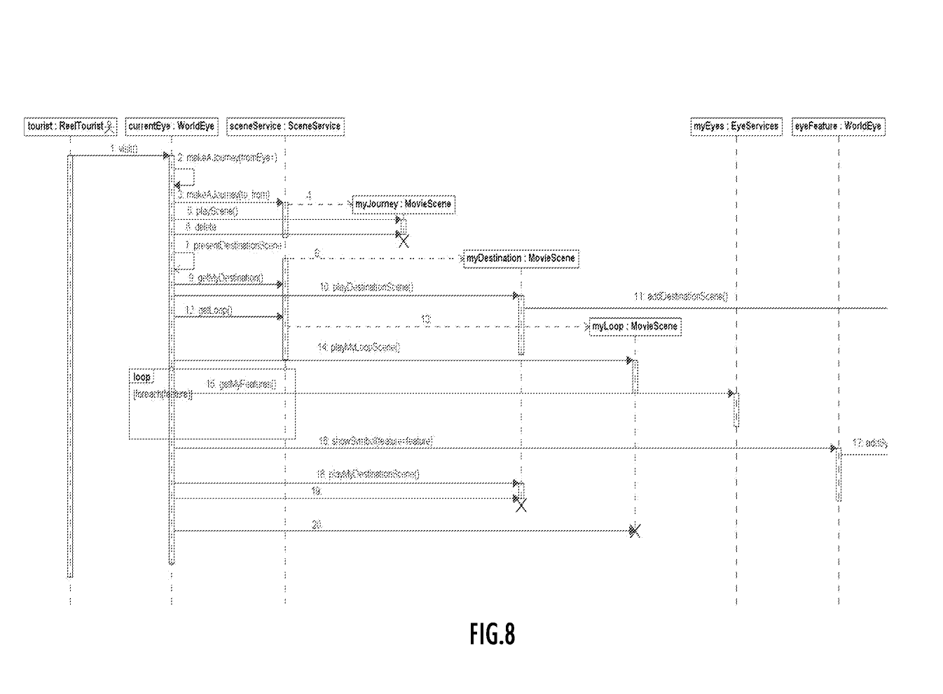

Referring to FIG. 8, a sequence of activities is shown in this diagram. The sequence is activated when the user decides to visit a location indicated with an icon on the map currently displayed in a window (termed “World Eye”). The selection of the icon initiates services called “Scene service”, “My Journey”, “My Destination”, “My Loops”, “My Eyes”, “Eye Feature” and “Canvass”, as will be described below. The selection of an icon appearing in the window calls 1 a visit( ) routine or module. The journey scene to the next lower level location must be made and displayed. The process calls 2 a routine or module called makeAjourney(from Eye). This asks 3 for a scene from the Scene service to the “to” location. The Scene service creates 4 a journey animation between the “from” location. The created journey scene is then provided to the My Journey service in the window which plays 5 the scene to the user using a module called PlayScene( ). When the journey has been completed, the animation is destroyed, as indicated by 6. The destination location is then presented to the user by calling 7 the PresentDestinationScene( ) module. This calls 8 the GetDestination (the Eye) module from the scene service related to the selected icon's location. The destination scene is provided 9 to the My Destination service and a movie about the destination is played to the user by calling 10 the PlayScene( ) module. The scene is played by adding 11 the scene and specifying the scene and level to an AddScene (scene, level) module which moves the current canvas to a background layer in the canvas service. A loop is obtained 12 by specifying an identifier from a Scene service to GetLoop (identifier) module which creates 13 a movie scene through the scene service and then the my loop service plays the contents of the movie scene to the user using the PlayScene( ) call 14. Any features either associated with the current window or within the boundaries of the current feature's location will be presented 15 through a ShowDestinationFeatures( ) module, which causes the new features related to the current icon to be retrieved 16 using the GetFeatures( ) module and specifying the location identifier from the location services to access the My Eyes service. For each new feature found 17, a request is made of the window to show 18 the symbol on the canvas using ShowSymbol (canvas) module, which then adds the symbol from the EyeFeature service using AddSymbol (eye, level) to the canvas symbol layer. At any time the user may wish to replay 20 a movie. Selecting replay calls 21 the PlayScene( ) module which plays the destination scene again from the My Destination service. When the user no longer wishes to view the current location scene, it closes 22 the window which results in the scene within My Destination service and the My Loop service being destroyed 23 and 24.

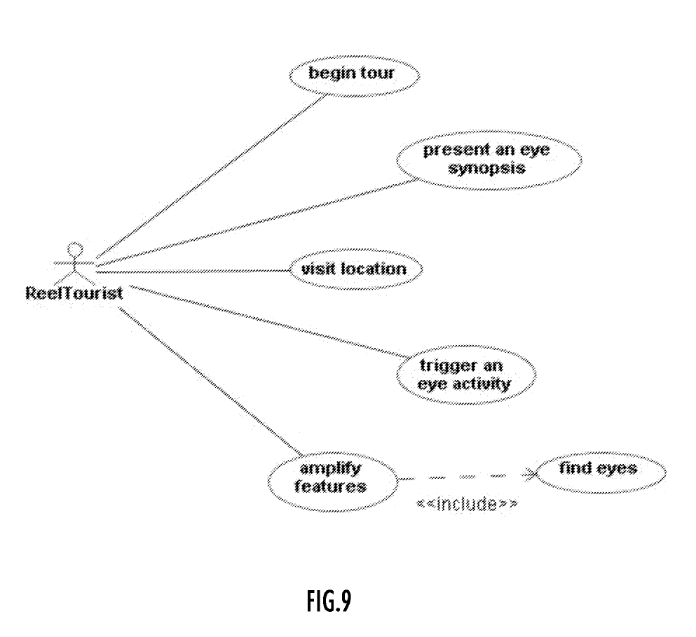

Referring to FIG. 9, a use case diagram is shown for a user actor. The user (indicated as “ReelTourist”) may begin their tour which presents them with a map. By moving a cursor over the icons (eyes), a synopsis of what is available at that location may be presented. They may then choose to visit that location in which case they trigger the journey and arrive at the destination. At the destination they may then trigger one or more activities available at that destination. The user can also amplify the icons to indicate-which ones relative to a desired feature. This process includes finding icons related to a specified search criteria. An example of this is described below.

In the example map of FIG. 3, Cottesloe beach is one of the eye icons available for selection. Depending on the point of view of the user they may be able to look out over the sea, they may be able to see people fishing from the mole, they may be able to look at the local shops or the restaurant located on the beach, or they may also be able to view the Surf Lifesaving Club and the activities of the surf lifesavers. All of these alternatives may be available at that particular location. All of the respective videos are available for viewing and are related to that particular location. If however, before selecting Cottesloe Beach, the person is interested in viewing surf lifesavers they may amplify the information available through each of the icons. They may type “surf lifesaver” into a filtering tool. The tool finds icons that meet the criterion of having “lifesaver” among the information associated with each icon. The eye icon above Cottesloe Beach would then be highlighted in relation to the other eye icons on the map of FIG. 3 thereby indicating that this geographic location has information relevant to surf life savers. Furthermore, when zoomed into the Cottesloe Beach map the icon above the Surf Lifesaving Club would be highlighted in relation to the other eyes above the other features of that particular location.

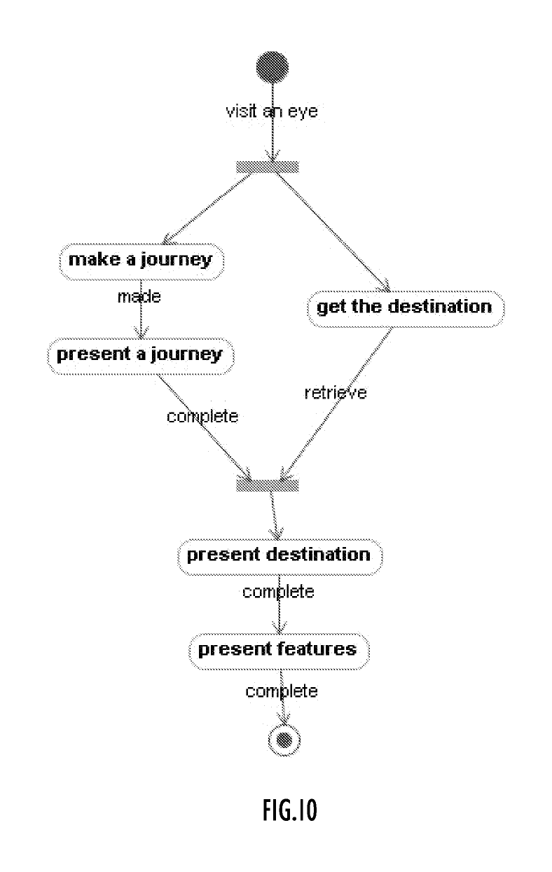

Referring to FIG. 10, an activity diagram is shown which illustrates the process of traveling from one displayed level to another. The process commences with selecting an icon. The first process is initiated when an icon is selected. An animated scene is generated to show the zooming in. The animation of the journey is then presented to the user. In the meantime the destination related to the selected icon is retrieved. Once the retrieved destination is reached as a result of the journey the new destination is presented to the user. This may be a lower level of the map, in which case a number of icons may be presented by which the user can make a further journey, or the information at the final destination may be presented, such as the video. Furthermore even once the video is completed and depending on the options presented, the user may then make a further journey either to another location at the same level, to a higher level location or the user may view another animation or use some other information available for selection.

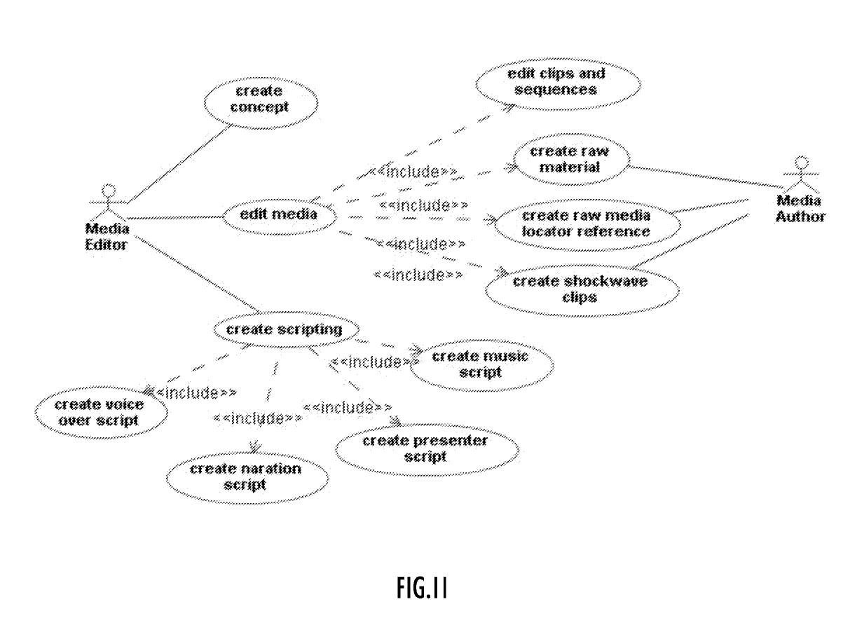

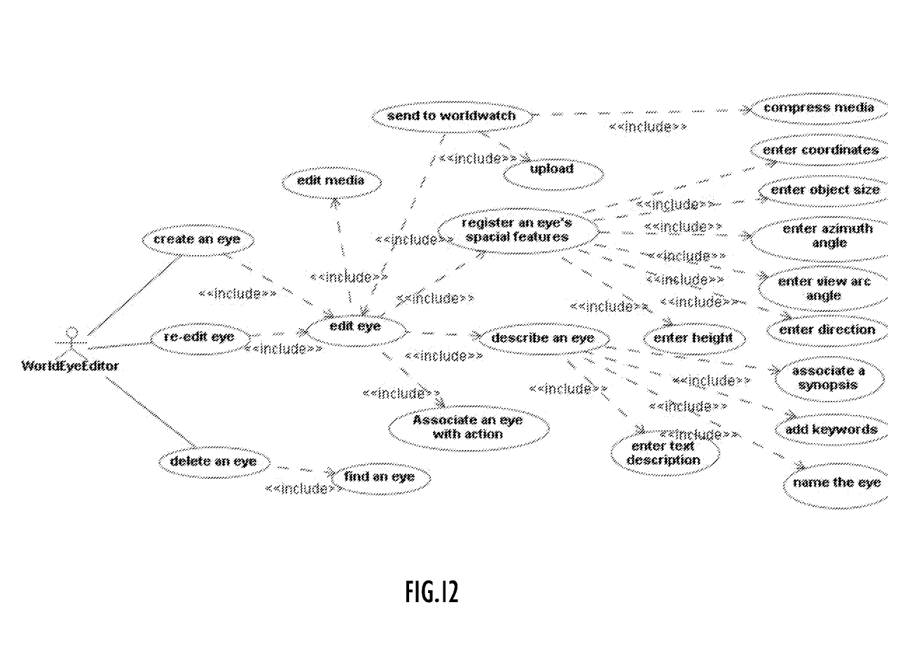

It is desirable to have the video presentations that are displayed to the user that are fresh and up to date. It is also desirable that the number of locations at which a person can view scenes continues to grow. FIGS. 11 and 12 show the process of creating media for display to the user and then creating the icon which is depicted on the map. Further below a business model for encouraging third parties to create this content is described.

Referring to FIG. 11, a media author, such as a camera man creates a set of raw material which is filmed and then put into an electronic format such as a shockwave clip. The material is given a location reference. A media editor then edits the media by creating a concept. Editing them includes editing existing clips and sequences, and obtaining new raw material, the location references and shockwave clips produced by the media author and storing them in a record. The media editor creates scripting which may include creating a voice over, narration script, presenter script and a music script. Media is then created, saved in record and ready for association with an icon.

With reference to FIG. 12, a “world” editor creates an eye icon which includes a process of editing the eye icon and associating media records and other information with the icon. To edit the media associate an action with the eye icon the media editor describes the icon including a text description giving it a name, adding keywords that are associated with that location and the concept behind the eye as well as a synopsis that will be displayed when the user hovers a cursor over the eye icon. The spatial features of the icon will be entered including the height, the direction, the arc angle, the azimuth angle, the object size and the co-ordinates using a map reference system or latitude and longitude co-ordinates. This is then sent to an organization operating the service, in this case notionally called WorldWatch, by compressing the media and then uploading it. The icon then becomes available for selection on the relevant map and the user can then be provided with the media when that particular icon is selected.

In addition the editor may want to re-edit an eye icon, in which case the relevant icon will need to be found and then the edit process commences as previously described. If an icon is to be deleted, again the relevant eye needs to be found and then it can be deleted.

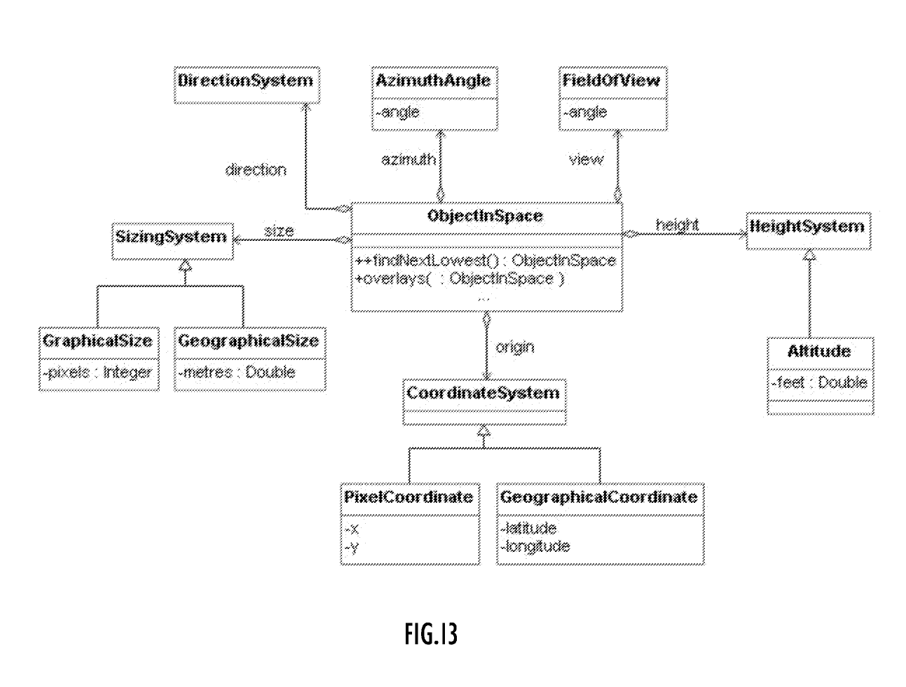

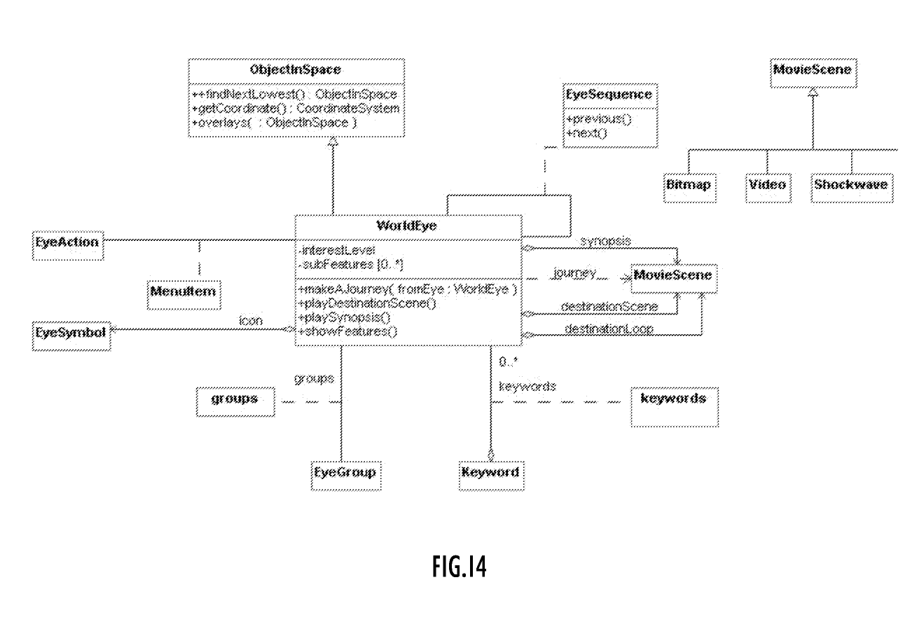

Referring to FIG. 13, a class of object is created to deal with the information and icon. The class of object called “WorldWatchEye”. The WorldWatchEye has attributes, behaviors and relationships with other classes as shown to achieve the effects described. Referring to FIG. 14, the class diagram for an ObjectInSpace class is shown which illustrates the attributes and behaviors of an object having this class. A characteristic of an object of this class is its ability to be positioned relative to any other object in space. The object in space is provided with a co-ordinate system attribute that is used to indicate the relative position of the object in space. If it is a geographic co-ordinate the measurement is in latitude and longitude. The direction system attribute provided to be related to the co-ordinate system. If the coordinate system is a geographic co-ordinate then the direction is a compass bearing or a measurement in degrees from the north compass bearing.

The object is provided with a height system attribute that provides a relative distance of the object above a point of reference. This may be an altitude provided in feet above the sea level. The sizing system attribute provides a measure of the width and height of the object. The object's width and depth is usually measured in meters for most objects are generally classified as rectangular objects. A sizing system is used to size the co-ordinates of the location in meters or kilometers as appropriate and in pixels for the graphical contents in relation to the map.

The attribute of azimuth angle provides the average azimuth angle relative to the visible horizon within the movie scene. The field of view attribute describes the complete field of view angle for the presentation associated with the object in space.

A number of behaviors associated with the ObjectInSpace class. These are used by other objects in space to determine their relationship with each other. The find next lowest behavior finds next lowest object in space that will appear within the scope of this object. An example of this would be a scene over Australia and we need to find the next lowest objects of interest within a geographic area of Australia. This may be a 1000 meter view of Perth but it will not return any detail in Perth. The overlays behavior tests to find out if this object overlays any other object in space.

The present invention can provide a real tourism experience by using visual presentation based on a geographic interface to allow the user to navigate and automatically travel to a selected geographic location and see a film about the location or some feature or subject located at the selected geographic location. When the feature is selected a new view of the selected feature is presented to the user providing more detail. This may be an interactive film or graphic about the selected feature that outlines yet further finer features that may be selected by the user. The features of interest will be grouped based on geographic location, density or subject matter and will provide various audio visual queues to either summarize the feature or notify the user of some other kind of event related to the feature.

When the user arrives at a destination they may choose to view one or more features and view an audio visual presentation about the selected feature. They choose to move across the scene to discover other features by use of horizontal or vertical panning or they may choose to go back to the previous level of detail by closing the current view window. The user may decide to amplify the features presented by selecting one or more subjects or date ranges of interest. Features related to these will be presented to the virtual traveler via enhanced icons. A filter may be applied instead of amplification, in which case those icons not meeting the criteria will not be displayed.

The voice over components and any text can be presented in one of multiple languages. The default method for selecting the language is to utilize the locale settings of the user's computer. In addition to this, the language may be manually overridden to present a voice over and text in the default language of the geographic location. Further, the user may manually select the voice over and text language. The locale setting of the user's computer is obtained from either the computer operating system or a computer program for providing the audio visual presentation.

The presentation can be automatically triggered from input of search criteria from some sort of input device. The search criteria can select the destination location to trigger the display of the journey and the audio visual presentation.

Examples of use of the present invention are described below.

A user named Sarah decides to take a trip to a Zoo, one that she has not yet visited so she connects to a zoo part of a portal according to an embodiment of the present invention and is immediately presented with a World globe complete with the Sun shining on it and stars in the background. Sarah lives in San Francisco so the globe shows San Francisco in its center. Sarah has already visited the local Zoo both as a real tourist and using the present invention so she decides to be a bit more adventurous and visit some other zoo in another part of the world. She uses a hand cursor to grab the globe and spins it/tilts it until Australia comes into view. She decides to visit Australia and selects it.

The view of Australia starts to zoom closer. Because Sarah started from the zoo portal, all the zoos in Australia show up as features scattered across the now lower orbit satellite view of Australia. She's not quite sure about which zoo to visit so she moves her pointer over the closest zoo which happens to be in Sydney. When she does, a pleasant voice announces that this is the Taronga Park Zoo that was established in 1884 plus a small map of the zoo is raised and other information about the zoo is presented. This short summary describes the range of fauna provided at this zoo however she is interested in orangutans but she's not sure which of the many icons displayed has a good population so she decides to raise the subject amplifier and types in “orangutans”.

Immediately, several of the WorldWatchEyes shown on the map become larger indicating some concentration of material on orangutans, one of the icons located in Perth, Western Australia stands out amongst the rest. Other icons disappear or shrink as they either have no material or only have minor exhibits. Sarah selects the icon located over Perth. The satellite view immediately begins to pan until it is centered over Perth at which point Perth starts to come closer and closer with more geographical detail becoming visible as the land around Perth gets closer. When the view is at about 1000 meters high, the now helicopter view shows new features that surround the Perth Zoo now at the center of the view.

Sarah is distracted by an icon over the beach at Cottesloe and decides to take a closer look and selects it. The map immediately becomes larger and is suddenly overlayed by streets and localities and amongst the landscape are several new icon scattered about. She sees one on the end of the mole at Cottesloe beach that looks interesting and selects it. A movie window opens and starts playing a film production complete with music and voice over showing the view from ground level. It is a typical and beautiful summer day with plenty of beach goers splashing about and the water looks clear and the scene is inviting. She wonders what it would look like in winter so she raises the season selector and drags the pointer over to winter. The scene immediately dulls, thick clouds appear and rain starts falling. The swells that rolled in now thunder on the now deserted beach sand with the pine trees in the background swaying as gusts of wind howl past her point of view. She decides to check out the view to sea and closes the current view and selects one near the surf lifesaving club that looks that way. When she has finished looking around, she cancels the winter view of Cottesloe and is immediately returned to her point of view at 1000 meters above Perth Zoo.

Having satisfied her curiosity, Sarah decides to select the icon located above the Perth. Zoo coordinate which is easy to find as it is enlarged because it has a large population of orangutans that she previously chose. From the view over Perth, an abstract drawing of the zoo begins to rise with the main sections of the zoo clearly visible. Within the Asian Rainforest section, an enlarged image of an orangutan sits picking ants from a simulated ant mound. Sarah has found her goal and decides to take a closer look and selects the image of the primate. The image of the orangutan grows and becomes surrounded by the image of a trail that has several moving icons along it. Each icon clearly depict areas of interest that users can view. At the top of the view is an image of Dr Claire Olton who is responsible for the care of Perth zoo's orangutans. To the left is an image of the rain forest. Other images surround the group of orangutans now busily working on the ant mound at the center of the screen. Sarah notices a sign over a bunch of bananas at the bottom of the image that says, “Take a complete Tour”. As Sarah is very interested in this subject, she decides to take a good look using the tour facility and selects this option. One of the icons on the background becomes enlarged, while at the same time, a movie player opens over the top of it. A movie clip containing the largest of the orangutans “Tuscan” starts playing accompanied by the sounds of the jungle mixed with native Indonesian music.

A voice talks about the plight of the orangutans and the decimation of their native forests. At the same time “Tuscan” enjoys entertaining the crowd by performing feats of skill only performed by orangutans. After this footage completes, the movie player moves over to expose the zookeeper icon, which enlarges. Then a clip containing the keeper starts playing. The tour continues to follow the trail until all aspects of the orangutan have been covered at which point the movie player closes and Sarah is left with the orangutan icon background. Sarah felt the keeper talk was quite interesting and decides to select the keeper to listen a second time at which point the movie player re-opens and start playing the keeper talk.

Part of the orangutan presentation talks about the plight of these magnificent creatures and Sarah decides she would like to make a donation by selecting the donation icon then entering an amount of US$100 which will be automatically billed to her account. She also really likes the look of the large male orangutan and decides to buy a poster from the associated product catalogue which also lists tee shirts, books and journals. She is passionate about orangutans so she decides to join the Friends of Orangutans focus group as a portion of the subscription fee will be used to purchase rain forests, which are orangutans' native habitat. After she joins the group, she decides to take a look at the many discussions underway by selecting the Forum icon.

Tang

Tang Zhu is a 13 year old middle class boy who lives with his family in Beijing. They are coming over to Australia to meet up and stay with some relatives living in Sydney. Tang is curious about the country he has never visited before and starts to investigate the opportunities. His immediate curiosity is the marsupial animals he has only heard about and seen in books.

He thinks that being mindful of proximity to where he is staying in Sydney will give him a greater chance of getting the opportunity to see some of these strange creatures. From a portal using an embodiment of the present invention, he enters into the computer the address he will be staying at in Sydney followed by the word Kangaroo, he is presented with a number of options of places meeting this criteria in the form of icons on a map. The map shows the proximity of these places to his visiting address and the icons allow him to view what the features of each particular place by clicking on each icon. For example, there is an icon for a small Australian Wildlife park with Emus, Koalas, Kangaroos, Wallabies, Echidnas, Dingoes and Wombats just a 10 minute drive from where he will be staying. There is another icon for an Australian Wildlife park a 35 minute drive away but this one includes Australian Reptiles and exotic Spiders. A 60 minute drive in the other direction is Taronga Zoo, which also has an icon. Tang takes a video tour of each of these locations (via each of the icons) and gets information on opening times, costs & features. He is also scouting for kids activities that are available along these routes so mom and dad won't mind stopping in on the way back.

Tang's Mom

Tang's mom is impressed with Tang's innovative online organization plan. She asks him to give her a quick run down so she can sit down and fulfill a few of her own curiosities. She sits down and enters some of the sights she knows about. She is presented with a map showing the following locations:

Opera House. She has a sneak preview tours and notices on the screen an option that allows her to see the surrounding tourist sights. She takes the option and does a preview tour of sights in the nearby area such as the Harbour Bridge, The Rocks, The City, Botanic Gardens, Chinatown, The Museum, Art Gallery etc. A Ferry ride to Manly prompts her to another part of Sydney as does a train ride to Bondi or a bus/ferry ride to Watson's Bay. She is presented with an on-screen button which if selected opens a booking form to make a booking.

The Blue Mountains. She takes a tour, sees the mountain railway, Gondola, Cafes etc., then again utilizes the ‘surrounding tourist site option’ and discovers Oberon and the Janolan Caves, The breathtaking cliff views of Blackheath, Afternoon tea at the Hydro Majestic, Blaxland, Katoomba etc.

She types the address they will be staying at as well as the words ‘clothes shopping’, ‘gift shopping’, ‘food shopping’ gives her a list of these relevant shops in close proximity. She also has the option of typing in the locations they will be touring to see what type of shopping is available to her there i.e. ‘clothes shopping Katoomba’. Again a purchase form or shopping cart is presented to buy goods.

Media will flow from a number of sources including independent film makers, specialized film makers, student film makers, novice film makers, home video graphers, commercial program owners and artists. The aggregation of audio and video media associated with a geographic location and area may provide the source of a number of business relationships. The organizing body providing the present invention can derive income from people that view scenes associated with each icon. People may choose to view icons and include an audio visual presentation such as a static image, a video production and an animation or simply an audio presentation. Each time a user plays one of these pieces of information a charge may be incurred or they may pay to access this for a period of time.

The present invention may be provided through a pay television channel instead of or as well as the Internet. In this instance viewers could pay to access the channel, or pay by the amount consumed, either on a time basis or on a number of videos activated.

The organizing body aggregates audio/visual media that is associated with a geographic location and area as “WorldWatchEye” objects. Each WorldWatchEye object may also be associated with a number of other WorldWatchEye objects within the area of the WorldWatchEye object.

In addition to this, WorldWatchEye objects may have an aggregator relationship with other WorldWatchEye objects that have a subject relationship.

The organizing body derives income from people that view the Scenes associated with WorldWatchEye objects. People may choose to view the video for WorldWatchEye objects that include an Audio/Visual presentation such as a static image, a video production, an animation or simply an audio presentation. An audience pays to view these associated scenes.

Within the organizing body infrastructure is the Media Editor/Author interface which is designed to allow individuals or organization to develop WorldWatchEye objects and upload them into portal. To encourage this activity, a royalty fee can be paid to the developers of the media and a copyright fee can be paid to the owners of the subject matter paid each time the organizing body derives income from an audience for viewing applicable WorldWatchEye objects. The organizing body will promote and manage this process and pass on payment when income is received from an audience.

To encourage growth of the overall WorldWatchEye object base and to discourage competition, a referral scheme for Media Editor/Author individuals or organizations that introduce other similar individuals or organizations can be established. This referral fee is a percentage of the new income derived from the new material and will continue to be paid to the referrer while income is derived from the WorldWatchEye objects produced by the new referral. This should be seen as a business promotional amplifier and will apply to all Media Editor/Author individuals or organizations. At this stage, the referral fee is paid for income from WorldWatchEye objects developed by the referred party only. In the future is may also include a percentage of referral fees developed by the referred party down several level of referral thereby encourage business building entrepreneurial activity especially in remote locations.

Individuals may elect to pay for WorldWatchEye objects to be viewed by audiences (advertising). In this circumstance, royalty and copyright payments to Media Editors/Authors still apply, however the beneficiary of the advertisement will pay the original fee for the viewing.

The selection of the icons by each user can be used stored and statistically analyzed to produce useful and valuable research on interests of certain demographics. This demographic information may be sold. An example is a trail of icons are selectable then statistical analysis can show what topics are of more interest, what is the best way to present information, what age groups (or other demographic breakdowns) are interested in which subjects etc. The navigation method of the present invention provides a unique manner of collecting such information.

The site may have other links and shopping facilities available. When these are selected as the result of navigation from this portal(s) charges can be applied for making such transactions. Examples are retail transactions, donations, organization memberships etc. The path of navigation alone or in combination with keywords can be used to select what other links are presented to the user.

It will be understood to persons skilled in the art of the invention that many modifications may be made without departing from the spirit and scope of the invention.

In the claims of this application and in the description of the invention, except where the context requires otherwise due to express language or necessary implication, the words “comprise” or variations such as “comprises” or “comprising” are used in an inclusive sense, i.e. to specify the presence of the stated features but not to preclude the presence or addition of further features in various embodiments of the invention.

What is claimed is:

1. A method of navigating to information, comprising:
displaying a first geographic image;
receiving input from an input device that selects a location on the first geographic image; and
retrieving an information segment related to the selected location.

2. A method of displaying information, comprising:
navigating to the information according to the navigation method defined in claim 1; and
displaying the information selected by the navigation method.

3. A system, comprising:
means for providing a service of navigating to information according to the method of claim 1; and means for charging by one or both of the following methods:
charging for access to the service; and
charging for each information segment provided.

4. A method of creating an active link to media content for use with a browser, the method comprising:
associating the link with a geographic location;
overlaying an icon on the location on a geographic image; and,
waiting for selection on the icon; and
upon selection of the icon the link is activated to cause the browser to access the media content;
wherein activation of the link initiates transfer of the media content to the browser.

5. A method of selecting media content linked to an icon for display on a browser, the method comprising:
providing an icon for accessing a link by selection of the icon, the icon being displayed over a geographic image;
providing a plurality of media content related to the geographic location;
associating searchable information related to each item of media content with the respective item of media content;
receiving a selection of the searchable information; and
linking selection of the icon to the respective media content according to the selected searchable information.

6. A method of service provision, comprising:
providing information by selecting a geographic location on a map;
providing a link to a service related to the information or the geographic information from the selected information or displayed at the same time as the geographically selected information; and
in the event that the link is activated then providing the service.

7. A business method comprising:
providing a service of navigating to information as defined in claim 1; and
charging by one or both of the following methods:
charging for access to the service; and
charging for each information segment provided.

8. A system for navigating to information comprising:
means for displaying a first geographic image;
means for receiving input from an input device that selects a location on the first geographic image; and
means for retrieving an information segment related to the selected location.

9. A system for displaying information comprising:
means for navigating to the information according to the navigation system defined in claim 8; and
means for displaying the information selected by the navigation system.

10. A system for creating an active link to media content for use with a browser, the system comprising:
means for associating the link with a geographic location;
means for overlaying an icon on the location on a geographic image; and
means for waiting for selection on the icon.

11. The system of claim 10, further comprising:
means for initiating transfer of the media content to the browser upon activation of the link.

12. A system for selecting media content linked to an icon for display on a browser, the system comprising:
means for providing an icon for accessing a link by selection of the icon, the icon being displayed over a geographic image;
means for providing a plurality of media content related to the geographic location;
means for associating searchable information related to each item of media content with the respective item of media content;
means for receiving a selection of the searchable information; and
means for linking selection of the icon to the respective media content according to the selected searchable information.

13. A system for service provision, comprising:
means for providing information by selecting a geographic location on a map; and
means for providing a link to a service related to the information or the geographic information from the selected information or displayed at the same time as the geographically selected information; and in the event that the link is activated then providing the service.
